(19) United States
(12) Patent Application Publication
(10) Pub. No.: US 2007/0125162 A1
(43) Pub. Date: Jun. 7, 2007

(54) Wireless liquid-level measuring free pour spout

(76) Inventors: Babak Robert Ghazi, West Atlanta, GA (US); Paul Sakichi D'Arrigo, Atlanta, GA (US)

Correspondence Address: NEEDLE & ROSENBERG, P.C., SUITE 1000, 999 PEACHTREE STREET, ATLANTA, GA, 30309-3915, US

(21) Appl. No.: 11/455,282

(22) Filed: Jun. 15, 2006

Related U.S. Application Data
(60) Provisional application No. 60/595,214, filed on Jun. 15, 2005.

(51) Int. Cl. G01F 17/00; G01F 23/28

(52) U.S. Cl. 73/149; 73/290 V

(57) ABSTRACT

Disclosed are systems, apparatuses and methods for determining the amount of liquid contained within a vessel. In one aspect, a liquid dispensing apparatus is provided comprising a pour spout mountable to an opening formed by a liquid containing vessel. A range sensor assembly is housed within the pour spout and comprises a trigger pulse source capable of receiving an actuation signal to thereby provide a trigger pulse and an echo pulse detector capable of providing an echo pulse detection signal. A microcontroller is provided in communication with the range sensor assembly. The microcontroller is configured to send an actuation signal to the trigger pulse source and to receive an echo pulse detection signal from the echo pulse detector, and, in a further aspect, can be configured to determine an elapsed time occurring between an actuation of the trigger pulse source and a subsequent detection of an echo pulse.

### CROSS REFERENCE TO RELATED APPLICATIONS

This application claims priority to U.S. Provisional Patent Application Ser. No. 60/595,214, which was filed Jun. 15, 2005, the disclosure of which is hereby incorporated by reference in its entirety for all purposes.

### FIELD OF THE INVENTION

This invention relates to an automatic level-sensing system, integrated into a container pour spout, for use in taking an inventory of products dispensed from full and partially full containers.

### BACKGROUND OF THE INVENTION

The accurate and real-time inventory of beverages such as liquor is crucial to long-term profitability of establishments that dispense the like. Without auditing, over-pouring and unmonitored distribution of beverages can become detrimental to profitability.

Current methods of auditing beverage distribution include manual measurement of contents, by methods such as weight and estimation. These methods limit inventory knowledge to certain periods where measurements were taken. Other automatic measurement systems involve control of the flow of liquid as described in U.S. Pat. No. 5,731,981 issued to Simard. Still further, another device described in U.S. Pat. No. 6,892,166 issued to Mogadam involves calculating the amount of liquid poured from the container by making assumptions of fluid flow based on tilt and timing.

There is a need in the art for systems, apparatuses and methods that can enable constant and accurate real-time measurement. This would provide higher visibility and would allow better tracking of dispensing on a per-dispensing basis. Every container is reconciled automatically, eliminating the need for manual measurements of inventory.

### SUMMARY OF THE INVENTION

The present invention is based, in part, upon systems, methods, and apparatuses that can enable an accurate and real-time volume measurement based on liquid level inside a container. To this end, in one aspect, it is an object of the present invention to enable a wireless transmission of the measurement to a computing device that calculates the current volume inside the container. This data can then be used to create an accurate inventory of the entire beverage vending operation. In another aspect, it is an object of the present invention to enable one to make measurements using ultrasonic, optical, or other intra-container distance-measuring techniques. In another aspect, the present invention does not calculate or estimate measurements based solely, or in part, on assumptions about the fluid flow (e.g., flow rate, the presence of or absence of laminar flow, viscosity, etc.) exiting the container. In another aspect, the present invention can enable an independent measurement of liquid-level height inside a container. Hence, each calculation of liquid volume in the container is not affected by any previous or subsequent measurements. In another aspect, the present invention can uniquely identify each container and log the measurement into a database that keeps track of changes in a specific container at any point in time. In another aspect, the present invention is unobtrusive to the vending operation by not inhibiting or controlling the flow of the liquid or beverage in any way.

Accordingly, in one aspect, the present invention provides a liquid dispensing apparatus, comprising a pour spout mountable to an opening formed by a liquid containing vessel; a range sensor assembly mounted within the pour spout; and a microcontroller in communication with the range sensor assembly. In one aspect, the range sensor can comprise a trigger pulse source capable of receiving an actuation signal to thereby provide a trigger pulse and an echo pulse detector capable of providing an echo pulse detection signal. In one aspect, the microcontroller is configured to send an actuation signal to the trigger pulse source and to receive an echo pulse detection signal from the echo pulse detector. In this aspect, the microcontroller is further configured to determine an elapsed time occurring between an actuation of the trigger pulse source and a subsequent detection of an echo pulse.

In another aspect, the present invention provide a system for monitoring the amount of liquid within a vessel. In is contemplated that the system can comprise a plurality of liquid dispensing apparatuses disclosed herein.

In still another aspect, the present invention provides a method for monitoring an amount of liquid dispensed from a container. The method comprises the steps of: providing a liquid dispensing apparatus mounted to an opening formed by a liquid containing vessel; providing an actuation signal to actuate a trigger pulse source to thereby provide a trigger pulse propagating toward a surface of the liquid contained within the vessel; detecting an echo pulse resulting from an interaction of the trigger pulse with the surface of the liquid contained within the vessel to thereby provide a detection signal received by a microcontroller; determining an elapsed time occurring between the actuation of a trigger pulse and the receipt of an echo pulse detection signal provided by the echo pulse detector; and determining a distance from the liquid level surface to a predetermined location positioned between the liquid level surface and the opening formed by the liquid containing vessel.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain embodiments of the instant invention and together with the description, serve to explain, without limitation, the principles of the invention.

FIG. 1 illustrates a wireless inventory system.

FIG. 2 illustrates a block diagram of an electronic liquid monitoring assembly according to one aspect of the present invention.

FIG. 3 illustrates a schematic diagram of a process of measuring the liquid level in a container, according to one aspect of the present invention.

FIG. 4 illustrates the liquid level measuring process used by the pour spout microcontroller.

### DETAILED DESCRIPTION OF THE INVENTION

The following description of the invention is provided as an enabling teaching of the invention in its best, currently known embodiment. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a system comprising a “liquid dispensing apparatus” includes embodiments having two or more such liquid dispensing apparatuses unless the context clearly indicates otherwise.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As summarized above, the present invention relates to systems, apparatuses, and methods for monitoring the amount of liquid contained in a vessel or container such as, for example, a bottle. In one aspect, an apparatus according to the present invention can be integrated into a pour spout for use in monitoring an amount of liquid contained in a bottle. Still further, it will be appreciated that a system of the present invention can comprise one or more of the inventive apparatuses and can be used to collectively and/or simultaneously monitor an amount of liquid contained in one or more liquid containing vessels. For example, in one aspect, a system or apparatus of the present invention can be used to monitor inventory in a beverage dispensing establishment such as a bar, tavern or restaurant.

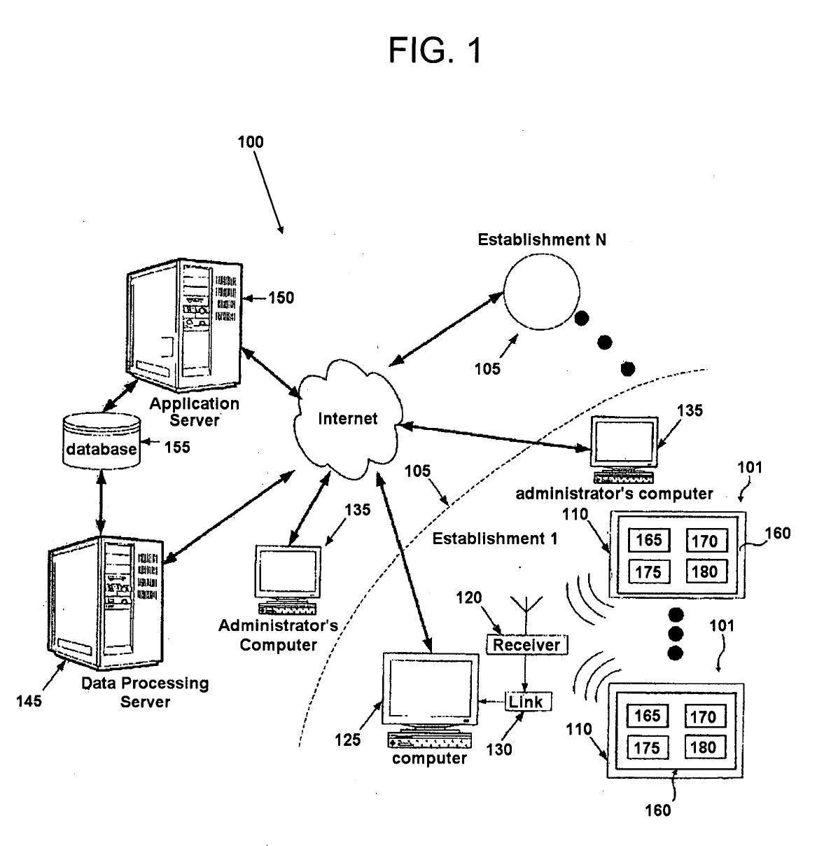

FIG. 1 generally illustrates an exemplary liquid monitoring system 100 according to one aspect of the present invention. It is contemplated that this system can allow an administrator to monitor liquid consumption and/or remaining inventory at one or more establishments 105 (e.g., one or more beverage dispensing establishments such as a bar, restaurant, or taverns). As shown, this system can comprise one or more system components that are located onsite at each establishment 105 and one or more system components that are located remotely or offsite from the establishment. For example, at a given establishment, the system can comprise one or liquid dispensing apparatuses 101, to be described in more detail below, a data receiver 120, a data collection device or appliance, such as a computer 125, and a communication link 130, such as, for example, a conventional RS232 link, for communicatively coupling the receiver 120 and computer 125. As shown, the total system can be expanded to comprise a plurality of any number “n” dispensing apparatuses for use in monitoring the liquid level in “n” number of liquid containers. Further, it should also be appreciated that the system can be expanded to monitor one or more liquid dispensing apparatuses at a plurality of any number “n” establishments.

The system can also include computers 135 for the administrators of the establishment. As shown in FIG. 1, the administrator computers can be located onsite and/or offsite from the establishment. Outside of the establishment 105, the system can also comprise a data processing server 145, an application server 150, and a database 155. It is contemplated that the data processing server and the application server can, for example, communicatively couple respectively to the local computer 125 and the administrator computers 135 through the Internet.

Each liquid dispensing apparatus 101 comprises a pour spout 110 connectable to an opening formed by a liquid container or vessel. Housed within the pour spout is an electronic liquid monitoring assembly 160 comprised of a range sensor assembly 165, microcontroller 170, power supply 175, and a data transmitter 180. In use, this electronic liquid monitoring assembly is able to generate data relating to the amount of liquid within the container. Each spout's electronic assembly can then transmit this data relating to the amount of liquid contained within the container to which it is connected, to the receiver 120. In one aspect, it is contemplated that the electronic assembly can provide data indicating the actual amount of liquid dispensed from a corresponding liquid container or vessel. However, in an alternative aspect, it is also contemplated that the electronic assembly can generates raw data relating to the amount of the dispensed liquid. As further described below, the data processing server 145 can then converts the raw data to the actual amount of the dispensed liquid.

The data generated by each electronic liquid monitoring assembly can be transmitted to the receiver 120 by the data transmitter 180. The data transmitter can be any convention wireless transmitter, such as a radio frequency transmitter that can transmit radio signals to a radio receiver 120. Also, it is further contemplated that, in addition to data relating to the amount of liquid contained within the vessel, the data transmitter can in another aspect transmit an engage signal to the receiver each time its spout is placed on a liquid container. Likewise, a disengage signal can also be sent to the receiver each time its spout is removed from the liquid container. This engage and disengage signal feature, as discussed in more detail below, is contemplated for use as a tamper switch indicating a possible tampering with the monitoring system by, for example, the unauthorized disconnecting or removal of a liquid dispensing apparatus from a liquid container.

The transmitter can, if desired, be configured to transmit each signal multiple times and at random intervals when a signal triggering event occurs (e.g., an engage, disengage, or pour event occurs), in order to ensure reliable reception. Still further, the signal can also include a data packet that contains a serial number, a sequence number, and/or an event identifier. The serial number can be used to provide the identity of a spout, which, as further described below, can be assigned (via software) to a particular type of liquid (e.g., to a particular liquor brand) for each establishment or customer. Hence, the serial number can be used by the data-processing server to identify the type of liquid stored in the container attached to the spout. The sequence number can be used to provide a count of each unique event of each serial-numbered unit, and thereby can be used to differentiate the reception of different unique events from the same serial-numbered unit. Still further, the event identifier can be used to specify the type of event that has occurred. As mentioned above, the event-types can include a spout engage, spout disengage, and/or a liquid distance measurement resulting from a pour event.

The receiver 120 can forward each packet that it receives from the transmitter 180 to the computer 125 through a communication link. The communication link can be any conventional wired or wireless communication link. For example, in one aspect, this communication link 130 can be formed by an RS232 cable connecting the RS-232 ports of the computer and receiver. Alternatively, the communication link can be formed by a conventional wireless connection according to known IEEE 802.11XXX protocols, including for example 802.11(b), and 802.11(g). As mentioned above, each transmitter can transmit each signal multiple times and at random intervals in order to ensure reliable reception. After forwarding a received packet to the computer, the receiver can discard the other identical copies of the packet that it has received. In still another aspect, it is contemplated that the receiver can store in a table the serial number and sequence number of each packet that it forwards to the computer, and discard the received packets that have serial and sequence numbers that match serial and sequence numbers recorded in the table. This table can be, for example, a “first-in-first-out” or a FIFO table. Thus, when it fills up, the first entry in the table is deleted in order to record the next entry.

The computer can store to memory the packets of data that it receives from the receiver in a data file. The computer can be a typical personal computer, workstation, or server. In one aspect, the computer can be a data-collecting “brick” with minimal or no interactions with individuals at the establishment. Still further, at pre-determined intervals (e.g., every five minutes, every 10 minutes, etc.), the computer can send, via the Internet, the data file with the collected packet to the data processing server 145. The transmitted data file can, as described above, contain an identifier of the establishment from which the data was collected. It is further contemplated that the computer 125 can connect to the Internet through a dedicated high-speed connection, such as a broadband DSL or Cable connection.

The data-processing server can either directly connect to the Internet, or can connect to the Internet through a Web Server (not shown), to receive the data files transmitted by the computer 125. As further described below, the data-processing server can convert the raw packet data that it receives to the actual amount of the dispensed liquid and/or actual amount of liquid remaining within the container. This server can then store the generated amount of liquid in the database 155.

An administrator of the establishment can then search the database to obtain various business-related reports, displays, or other information. For example, the administrator can query this database through the application server, which communicatively couples to the administrator's computer 135 through the Internet. Like the data-processing server, the application server 150 either directly connects to the Internet, or connects to the Internet through a Web Server (not shown).

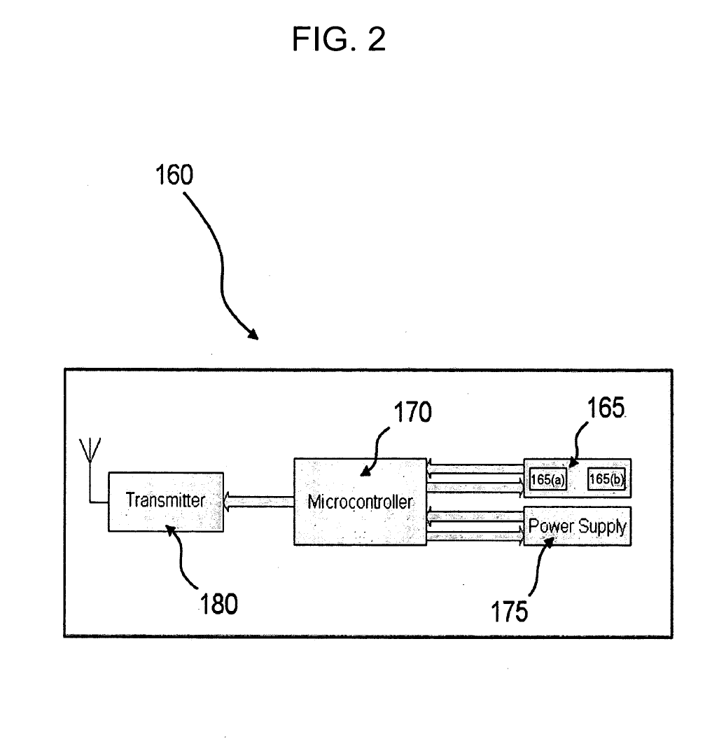

As summarized above, each liquid dispensing apparatus 101 of the present invention comprises an electronic liquid monitoring assembly 160 housed or otherwise mounted to a pour spout 110 that is connectable to an opening formed by a liquid containing vessel. With reference to FIG. 2, the electronic assembly 160 comprises a range sensor assembly 165, microcontroller 170, power supply 175, and a data transmitter 180. The range sensor assembly 165 is in communication with the microcontroller and comprises a trigger pulse source 165(a) and an echo pulse detector 165(b).

The trigger pulse source 165(a) is in communication with and capable of receiving an actuation signal from, the microcontroller to thereby provide a trigger pulse propagating towards a liquid within the container. The trigger pulse can be provided in any form of energetic pulse, including for example, an electromagnetic pulse, such as infrared radiation. Alternatively, the trigger pulse can be a sonic or ultra sonic pulse. Still further, the pulse can be an optical pulse. To this end, in an exemplary aspect, a commercially available trigger pulse source suitable for use in the present invention is the 40KT08 Ultrasonic Transmitter, available from SensComp, Livonia, Mich., USA.

Similarly, the echo pulse detector is also in communication with the microcontroller and is capable of providing an echo pulse detection signal when an echo pulse has been detected. The echo pulse detector can, depending on the particular trigger pulse, be selected to detect an echo pulse in any form of energetic pulse, including for example, an electromagnetic echo pulse, such as infrared radiation. Alternatively, the echo pulse detector can be selected to detect a sonic or ultra sonic pulse. To this end, in an exemplary aspect, a commercially available echo pulse detector suitable for use in the present invention is the 40RT08 Ultrasonic Receiver, also available from SensComp, Livonia, Mich., USA.

In use, the range sensor assembly is capable of performing a measurement of the elapsed time occurring between the moment a trigger pulse is emitted from the range sensor to the moment a reflection or echo pulse from the surface of the remaining liquid in the container is received or detected by the echo pulse detector.

The electronic liquid monitoring assembly further comprises a microcontroller 170 to coordinate control of the various electronic liquid monitoring assembly components. In particular, the microcontroller is provided in communication with both the trigger pulse source and the echo pulse detector components of the range sensor assembly. The microcontroller can send an actuation signal to the trigger pulse source to thereby provide a trigger pulse. The actuation signal can, for example, be initiated by a tilt switch, which can also be mounted to or within the pour spout. An exemplary tilt switch suitable for use in the instant invention includes the GP1S36HEX tilt switch available from Sharp. According to this aspect, the microcontroller can detects that the tilt switch has generated an active signal (i.e., whenever the tilt switch closes) for more than a predetermined amount of time (such as, for example and not meant to be limiting, 0.3 seconds), indicating that a container has been titled, most likely pursuant to a pouring event, and that a portion of liquid has been dispensed from the container. Each time the tilt switch closes for the predetermined period of time, the tilt-switch signal is active, and thus signals the microcontroller to actuate the trigger pulse source. Any conventional and commercially available microcontroller capable of performing one or more feature set forth herein can be used in accordance with the present invention. However, in one exemplary aspect, a suitable microcontroller is the PIC18F452, available from Microchip.

The microcontroller is also in communication with a conventional power supply 175. One of skill in the art will appreciate that the power supply can be any power supply suitable for use in connection with the electronic components described herein.

The data transmitter 180 can also be provided in communication with the microcontroller. As discussed above, the transmitter can transmit packets of data signals containing distance calculations that it receives from the micro-controller to a remote receiver. The transmitter can, for example, transmit each signal multiple times at random intervals in order to ensure reliable reception. An exemplary and non-limiting commercially available transmitter that is suitable for use in the present invention is the nRF24AP1 wireless communications RF Chip, available from NORDIC.

As discussed above, the firmware of the receiver can be designed to forward each packet that it receives from the transmitters 180 to the computer 125 through a wired or a wireless link, and to use a look-up table to discard duplicate copies of the same packets that it receives. Specifically, the receiver can store in a table the serial number and sequence number of each packet that it forwards to the computer, and discards the received packets that have serial and sequence numbers that match serial and sequence numbers recorded in the table. The table can be a FIFO table; hence, when it fills up, the first entry in the table is deleted in order to record the next entry.

The computer stores the packets that it receives from the receiver in a data file. The computer can be a typical personal computer, workstation, or server. In some embodiments, this computer is a data-collecting “brick” with minimal or no interactions with individuals at the establishment. At pre-specified intervals (e.g., every five minutes), the computer sends through the Internet the data file with the collected packet to the data processing server 145. The transmitted data file identifies the establishment from which the data was collected. In some embodiments, the computer 125 connects to the Internet through a dedicated high-speed connection, such as a DSL connection.

A data processing server can convert the raw distance packet data into an actual amount of liquid either remaining in a container or an actual amount that has been dispensed. The resulting computations can also be stored in a database. In an exemplary aspect, an administrator of an establishment can then search the database 155 to obtain various business-related reports, displays, or other information. As mentioned above, the administrator queries this database through the application server, which communicatively couples to the administrator's computer 135 through the Internet. Examples of analysis reports that the administrator can generate include reports relating to sales, inventory depletion, cost of goods sold, and pouring cost calculations.

To generate such reports, the administrator initially supplies a customer identification and/or password. The application server then checks the supplied information to qualify the administrator to query the database. The administrator can then query the database to generate any number of reports, such as those mentioned above. The administrator typically generates such reports by selecting the type of report that he or she wishes to see and providing a time frame for the report. In some embodiments, the application server generates the reports by retrieving data from the database and performing calculations based on the retrieved data.

As mentioned above, the electronic liquid monitoring assembly is housed within or otherwise mounted to a pour spout 110. To this end, the pour spout can be any conventional free pour spout configured to be connected to a liquid containing vessel, such as for example, a bottle. In one aspect, the pour spout can have a bottom portion sized and shaped to be inserted into an opening formed by the vessel. The bottom portion can comprise a cork or rubber like material that flexes to snuggly connect the spout bottom portion to the liquid vessel. It is contemplated that a cascade of different size corks or rubber materials can also be mounted on the bottom portion in order to allow the spout to snuggly connect to liquid vessels having different sized openings. In another aspect, it is contemplated that the spout bottom portion can have a threaded portion configured to complement a threaded portion a liquid vessel such that the spout can be threadably connected to the liquid containing vessel.

The free pour spout further comprises a fluid-flow passageway in communication with interior volume of the liquid containing vessel. An optional breather tube can also be provided such that when the spout is positioned on a liquid container, the breather tube can provide an air inlet that allows better fluid flow through the passageway. The dimensions of the fluid-flow passageway can be specifically selected to ensure laminar fluid flow of liquid when the liquid-container and hence the spout are inclined at a certain angle (e.g., 20 degrees) past the horizontal axis of the liquid-container. For instance, in some embodiments, the ratio (L/D) of the passageway's length (L) and width (or diameter D) is selected to be equal to or less than 20 in order to ensure laminar fluid flow.

As briefly discussed above, each liquid dispensing apparatus can optionally comprise a tamper switch which senses whether or not the pour spout is mounted in the opening of a liquid container. The tamper switch can be in the formed by an on-off button that springs up and seals a sense switch when the bottom portion of the spout is inserted into a liquid container. When the bottom portion is removed from the liquid container, the on-off button springs back and thereby opens the sense switch. In some embodiments, the on-off button can be pushed up by the liquid container lip that defines the container's opening. In other embodiments, this button is pushed up by another mechanism, such as the cork of the bottom portion.

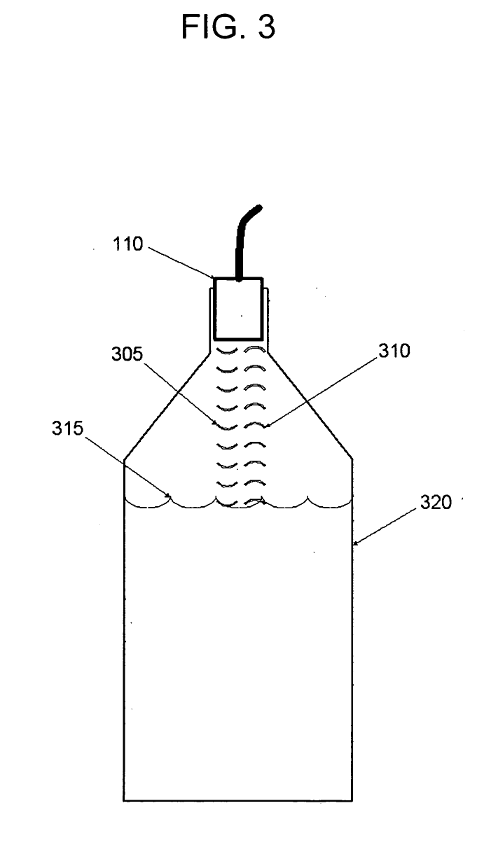

With reference to FIG. 3, in use, the microcontroller can actuate the trigger pulse source so as to emit an energetic pulse (305), such as an ultrasonic sound pulse or an infrared light pulse, down to the liquid level in a container (320). The pulse is then reflected back (310) by the surface of the liquid (315) in the container (320). If no liquid is present in the container, the trigger pulse (305) is reflected back by the bottom of the container itself (320). The elapsed time between the emitted pulse (305) and receipt of the reflected pulse by the echo pulse detector is then determined by the microcontroller, housed within the pour spout 110. The elapsed time measurement is then used by the microcontroller to calculate the distance (D) to the surface of the remaining liquid in the container based on the speed (V) of the pulse emitted as well as the time (T) measurement using a preprogrammed algorithm that converts this time into a distance measurement based on EQ 1.
D=V×(T/2) EQ. 1

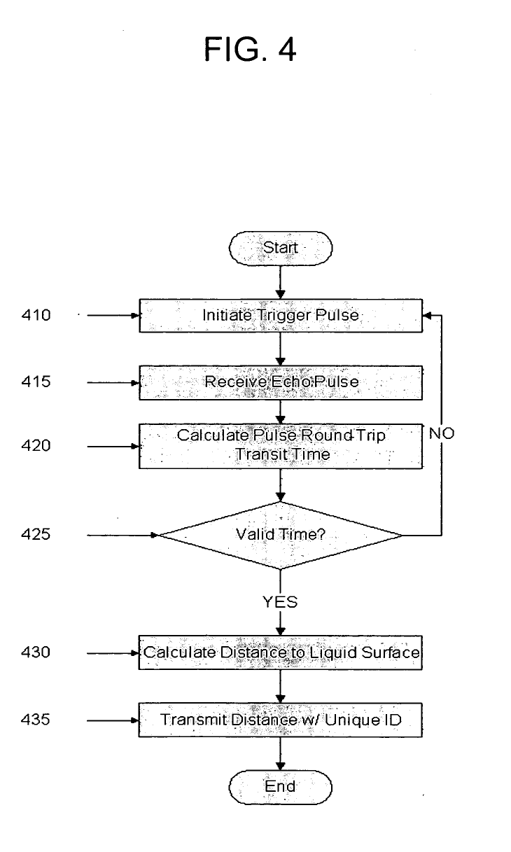

FIG. 4 illustrates an exemplary distance measuring process, performed by the electronic liquid monitoring assembly of the present invention. The distance-measurement process 400 illustrated in FIG. 4 starts when the microcontroller initiates a trigger pulse 410 to the range sensor and receives an echo pulse 415 from the range sensor. This time duration between the emission of a trigger pulse and the receipt of the echo pulse is then calculated 420 by the microcontroller. If the time is valid based on pre-programmed assumptions 425 in the microcontroller, the distance to the liquid surface is calculated 430 based on the propagation speed of the trigger pulse and the round-trip transit time of the pulse emitted using EQ 1. This distance measurement is then wirelessly transmitted to the receiver with a unique identifying code 435 to identify the source of the measurement. This code is unique to each pour spout and can be associated with a particular container for inventory tracking. If the time is not valid, based on pre-programmed assumptions 425 in the microcontroller, then the process restarts.

In still another aspect, the present invention provides a method for monitoring the amount of liquid within a container. The method comprises first providing a liquid dispensing apparatus of the present invention mounted to an opening formed by a liquid containing vessel. The liquid dispensing apparatus can comprise: i) a pour spout mounted to the opening; ii) a range sensor assembly mounted within the pour spout and comprising a trigger pulse source capable of receiving an actuation signal to thereby provide a trigger pulse and an echo pulse detector capable of providing an echo pulse detection signal; and iii) a microcontroller in communication with the range sensor assembly. In one aspect, the microcontroller is configured to send an actuation signal to the trigger pulse source and to receive an echo pulse detection signal from the echo pulse detector, and is further configured to determine an elapsed time occurring between an actuation of the trigger pulse source and a subsequent detection of an echo pulse.

The trigger pulse source is actuated by providing an actuation signal. By actuating the trigger pulse source, a trigger pulse is provided propagating toward a surface of the liquid contained within the vessel. Further according to the method of the instant invention, once the trigger pulse has been reflected back toward the range sensor assembly, by either the interaction with the surface of a liquid contained within the vessel, or by the vessel itself, this reflected or echo pulse is detected by the echo pulse detector. The echo pulse detector then initiates a detection signal which is communicated to and received by the microcontroller.

An elapsed time occurring between the actuation of a trigger pulse and the receipt of an echo pulse detection signal provided by the echo pulse detector is then determined, from which the actual distance from the liquid level surface to a predetermined location positioned between the liquid level surface and the opening formed by the liquid containing vessel is calculated.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A liquid dispensing apparatus, comprising:
a pour spout mountable to an opening formed by a liquid containing vessel;
a range sensor assembly mounted within the pour spout and comprising a trigger pulse source capable of receiving an actuation signal to thereby provide a trigger pulse and an echo pulse detector capable of providing an echo pulse detection signal; and
a microcontroller in communication with the range sensor assembly, wherein the microcontroller is configured to send an actuation signal to the trigger pulse source and to receive an echo pulse detection signal from the echo pulse detector, and wherein the microcontroller is configured to determine an elapsed time occurring between an actuation of the trigger pulse source and a subsequent detection of an echo pulse.

2. The liquid dispensing apparatus of claim 1, further comprising a data transmitter in communication with the microcontroller unit and configured to transmit data from the microcontroller to a remote data receiver.

3. The liquid dispensing apparatus of claim 1, wherein the pour spout is a free pour spout.

4. The liquid dispensing apparatus of claim 1, wherein the liquid dispensing system further comprises a tamper switch interfaced with the microcontroller that can detect whether the pour spout is mounted to the opening formed by the liquid containing vessel.

5. The liquid dispensing apparatus of claim 1, further comprising a tilt switch interfaced to the microcontroller.

6. The liquid dispensing apparatus of claim 1, wherein the trigger pulse source is capable of providing an electromagnetic pulse and wherein the echo pulse detector is capable of detecting an electromagnetic echo pulse.

7. The liquid dispensing apparatus of claim 6, wherein the electromagnetic trigger pulse and electromagnetic echo pulse comprises infrared light.

8. The liquid dispensing apparatus of claim 1, wherein the trigger pulse source is capable of providing a sonic pulse and wherein the echo pulse detector is capable of detecting a sonic echo pulse.

9. The liquid dispensing apparatus of claim 1, wherein the microcontroller can compute a distance between a liquid surface level in a liquid containing vessel and the echo pulse detector.

10. The liquid dispensing apparatus of claim 8, wherein the microcontroller is programmed to compute the distance based upon an elapsed time between an actuation of a trigger pulse and a subsequent detection of an echo pulse.

11. A system for monitoring liquid consumption at an establishment, the system comprising:
a) a plurality of liquid dispensing apparatuses, comprising:
a pour spout mountable to an opening formed by a liquid containing vessel;
a range sensor assembly mounted within the pour spout and comprising a trigger pulse source capable of receiving an actuation signal to thereby provide a trigger pulse and an echo pulse detector capable of providing an echo pulse detection signal; and
a microcontroller in communication with the range sensor assembly, wherein the microcontroller is configured to send an actuation signal to the trigger pulse source and to receive an echo pulse detection signal from the echo pulse detector, and wherein the microcontroller is configured to determine an elapsed time occurring between an actuation of the trigger pulse source and a subsequent detection of an echo pulse,
wherein each spout is for mounting and wherein the determined elapsed time occurring between an actuation of the trigger pulse source and a subsequent detection of an echo pulse is for generating data regarding the amount of liquid dispensed from the container;
b) a local computer at the establishment for collecting data generated by the liquid dispensing apparatuses; and
c) an external server outside of the establishment that communicatively couples to the local computer through a communication network, the external server for obtaining from the local computer data relating to the data collected by the local computer, and for computing actual amounts of liquid poured from a plurality of the liquid containers based on the data obtained from the local computer.

12. The system of claim 11, wherein the communication network is a network of networks.

13. The system of claim 11, wherein the network of networks is the Internet.

14. The system of claim 11, wherein the external server is a first external server, wherein the system further comprises a second external server outside of the establishment, said second external server for generating business-related reports based on the data computed by the first external server.

15. The system of claim 14, wherein the business-related reports relate to costs associated with the actual amounts of poured liquid.

16. The system of claim 14, wherein the business-related reports relate to sale values associated with the actual amounts of the poured liquid.

17. The system of claim 14, wherein the business-related reports relate to remaining inventory of liquids.

18. The system of claim 14, wherein the first and second external servers operate on one computer.

19. The system of claim 14, wherein the first and second external servers operate on different computers.

20. A method for monitoring an amount of liquid dispensed from a container, comprising the steps of:
providing a liquid dispensing apparatus mounted to an opening formed by a liquid containing vessel, said apparatus comprising i) a pour spout mounted to the opening; ii) a range sensor assembly mounted within the pour spout and comprising a trigger pulse source and an echo pulse detector; and iii) a microcontroller in communication with the range sensor assembly, wherein the microcontroller is configured to send an actuation signal to the trigger pulse source and to receive an echo pulse detection signal from the echo pulse detector;
providing an actuation signal to actuate the trigger pulse source to thereby provide a trigger pulse propagating toward a surface of the liquid contained within the vessel;
detecting an echo pulse resulting from an interaction of the trigger pulse with the surface of the liquid contained within the vessel to thereby provide a detection signal received by the microcontroller;
determining an elapsed time occurring between the actuation of a trigger pulse and the receipt of an echo pulse detection signal provided by the echo pulse detector; and
determining a distance from the liquid level surface to a predetermined location positioned between the liquid level surface and the opening formed by the liquid containing vessel.
